(19) United States
(12) Patent Application Publication
(10) Pub. No.: US 2024/0181405 A1
(43) Pub. Date: Jun. 6, 2024

(54) A MIXING DEVICE AND METHOD FOR MIXING A FIRST SUBSTANCE AND A SECOND SUBSTANCE TO FORM A MIXED SUBSTANCE

(71) Applicant: MAGNETS FOR EMULSIONS N.V., OOSTKAMP (BE)

(72) Inventors: Nielsen Willemarck, ZOMERGEM (BE); Johan Adriaan MARTENS, SINT-JORIS-WEERT (BE)

(73) Assignee: MAGNETS FOR EMULSIONS N.V., OOSTKAMP (BE)

(21) Appl. No.: 18/553,897

(22) PCT Filed: Apr. 4, 2022
(86) PCT No.: PCT/EP2022/058886

§ 371 Date: Oct. 4, 2023

(30) Foreign Application Priority Data
Apr. 6, 2021 (NL) 2027917

(51) Int. Cl. B01F 25/312; B01F 23/50; B01F 25/53

(52) U.S. Cl. CPC B01F 25/31243; B01F 23/56; B01F 25/31252; B01F 25/53

(57) ABSTRACT

A mixing device for mixing first and second substances to form a mixed substance includes a housing having first and second inlets for first and second substances and an outlet for the mixed substance. A flow channel between the first inlet and the outlet and has a flow axis therebetween. The flow channel has a Venturi section having a side wall. A lateral feed opening in the side wall in a first lateral direction is connected to the second inlet, and the opening has a feed axis in said first lateral direction substantially perpendicular to the flow axis of the flow channel. Upstream from the lateral feed opening the side wall of the Venturi tube section forms a first constricted part having a first width in the first lateral direction and a second width perpendicular to the first lateral direction. The second width is larger than the first width.

The invention relates to a mixing device for mixing a first substance and a second substance to form a mixed substance.

Mixed substances such as dispersions or emulsions may be prepared for instance by using a device comprising a high shear mixer or by using a Venturi type mixer. Known mixing devices, for example the educator described in US2005/0189081, have the disadvantage that the solids are inserted in a cavernous mixing chamber being substantially larger than the initial venturi, thus creating a substantial pressure drop. This pressure drop greatly reduces the velocity of the first substance. US2005/0189081 suboptimally mixes the first substance with the second substance. Moreover, the plurality of diverging and converging sections generate a choked flow downstream of the mixing chamber further increasing back pressure and further reducing mixing efficiency.

The current invention relates to an improved Venturi type mixing device.

Such a mixing device comprises a housing having a first inlet for said first substance, a second inlet for said second substance and an outlet for said mixed substance; wherein a flow channel is arranged between said first inlet and said outlet, said flow channel having a flow axis between said first inlet and said outlet, and wherein said flow channel is provided with a constricted Venturi tube section, said Venturi tube section having a side wall; wherein a lateral feed opening is provided in said side wall in a first lateral direction, which lateral feed opening is connected to said second inlet, and said opening having a feed axis in said first lateral direction which is substantially perpendicular to the flow axis of said flow channel.

According to a first aspect of the invention upstream from said lateral feed opening the side wall of said Venturi tube section forms a first constricted part, and said first constricted part of the Venturi section has a first width in said first lateral direction and a second width in a second lateral direction perpendicular to said first lateral direction, wherein said second width is larger than said first width. Downstream from said lateral feed opening the side wall of said Venturi tube section may form a second constricted part having a third width in said first lateral direction and a fourth width in said second lateral direction, wherein said third width may be the same as said first width. Preferably the width of said lateral feed opening in said second lateral direction is approximately equal to (i.e. preferably at least 80% or 90% of) said second width of the first constricted part.

The use of a conventional Venturi with a tube section having a round cross section results in a ratio of the lateral feed opening surface vs. the constriction tube section surface area of (max) 1:1. As a result the quantity of the second substance that will be brought into the flow of the first substance will happen in approximately the same ratio. By using such a slitted venturi rather than a usual tubular Venturi a stronger turbulent flow can be created, resulting in better and/or faster mixing. Furthermore, the circumference of a slit is relatively high compared to a round tube, which results in higher shear force acting on the substances to be mixed, thereby resulting in a better or faster mixing. Furthermore the ratio between the lateral feed opening surface vs. the constriction tube section surface can be increased substantially, also resulting in a better or faster mixing. The slitted Venturi also creates the possibility to choose between different surface areas for the lateral feed opening, for instance by applying a reducer in said opening, for achieving an optimized feed ratio for the applicable second substance, in view of the underpressure suction force of the Venturi.

According to a second aspect of the invention, upstream from said lateral feed opening the side wall of said Venturi tube section forms a first constricted part, and said first constricted part of the Venturi section has a first width in said first lateral direction and a second width in a second lateral direction perpendicular to said first lateral direction, and downstream from said lateral feed opening the side wall of said Venturi tube section forms a second constricted part having a third width in said first lateral direction and a fourth width in said second lateral direction. Seen in said first lateral direction, on a first lateral side of the flow channel the wall of said second constricted part is substantially flush with the wall of said first constricted part, and the flow channel is widened in said second constricted part in the direction of a second lateral side of the flow channel such that said third width is larger than said first width, said second lateral side being opposite the first lateral side. Preferably the flow channel is widened in said second constricted part at the side of the lateral feed opening. This feature improves the mixing process by enhancing turbulence at the side of the flow channel where the second substance is being introduced in the stream of the first substance. By widening the second constricted part immediately after the lateral feed opening in one direction, strong turbulent eddies will be formed in the so created space, resulting in better and/or faster mixing. A further advantage of the flush walls is that the Venturi section can be cleaned more easily.

Preferably, only the third width of the flow channel of the second constricted part is widened at the side of the lateral feed opening.

Preferably, the third width of the flow channel in the second constricted part is constant, seen along the flow axis.

Preferably, the first width of the flow channel in the first constricted part is constant, seen along the flow axis.

Preferably, the flow channel between the first inlet and the outlet consists of the first constricted part and the second constricted part.

Preferably the housing is provided with magnets which extend adjacent the side wall of the second constricted part on both sides in the first lateral direction. In this manner the mixing substance may circulate through a magnetic field in order to positively affect the turbulent conditions of the flow. In WO 2004/043580 A1 a configuration is described in which the magnets improve the process of emulsification. It has been surprisingly found that the combination of the provision of magnets in combination with the strong turbulent conditions in the Venturi tube section further improves the emulsification process, in particular when the magnets are provided adjacent the side wall of the second constricted part.

Preferably the second width of the first constricted part is more than 1.5 times, preferably more than 3 times, more preferably more than 6 times the first width of the first constricted part. In the preferred embodiment the second width is approximately 10 times the first width.

Preferably the third width of the second constricted part is more than 1.25 times, preferably more than 2 times, more preferably more than 3 times the width first width of the first constricted part. In the preferred embodiment the third width is approximately 4 times the first width.

Preferably the fourth width of the second constricted part is approximately equal to (i.e. preferably 80% to 120% of) the second width of the first constricted part.

Preferably the width of the lateral feed opening in the direction of the flow axis is approximately equal to (i.e. preferably 80% to 120% of) the width of the lateral feed opening in the second lateral direction.

Preferably the surface area of the lateral feed opening is more than 1.25 times, preferably more than 2.5 times, more preferably more than 5 times the surface area of flow channel in the first constricted part. In the preferred embodiment the surface area of the lateral feed opening is 5.5 times the surface area of flow channel in the first constricted part.

Preferably the first width of the first constricted part is between 1 mm and 10 mm, preferably between 1.5 mm and 4 mm. In the preferred embodiment the first width is approximately 2 mm.

Preferably the third width of the second constricted part is between 2 mm and 100 mm, preferably between 4.5 mm and 20 mm. In the preferred embodiment the third width is approximately 8 mm.

In the preferred embodiment the housing is made of one integral part.

The invention also relates to a method for mixing a first substance and a second substance in a mixing device to form a mixed substance; wherein said mixing device comprises a housing having a first inlet into which said first substance is pumped under pressure, a second inlet into which said second substance is fed, and an outlet from which said mixed substance is discharged; wherein a flow channel is arranged between said first inlet and said outlet, said flow channel having a flow axis between said first inlet and said outlet, and wherein said flow channel is provided with a constricted Venturi tube section, said Venturi tube section having a side wall; wherein a lateral feed opening is provided in said side wall in a first lateral direction, which lateral feed opening is connected to said second inlet, and said opening having a feed axis in said first lateral direction which is substantially perpendicular to the flow axis of said flow channel; wherein upstream from said lateral feed opening the side wall of said Venturi tube section forms a first constricted part having a first width in said first lateral direction and a second width in a second lateral direction perpendicular to said first lateral direction; wherein said second width is larger than said first width.

In preferred embodiments of methods according to the invention said first substance comprises mainly water and said second substance comprises a powder, in particular a hydrophobic powder. The mixed substance may be for instance an emulsion or a dispersion, such as a cosmetic or pharmaceutical emulsion or gel, or a food emulsion or dispersion, such as a mayonnaise, a pectine solution, a batter or a sauce.

The invention will be elucidated by means of an exemplary preferred embodiment, with reference to the figures, wherein:

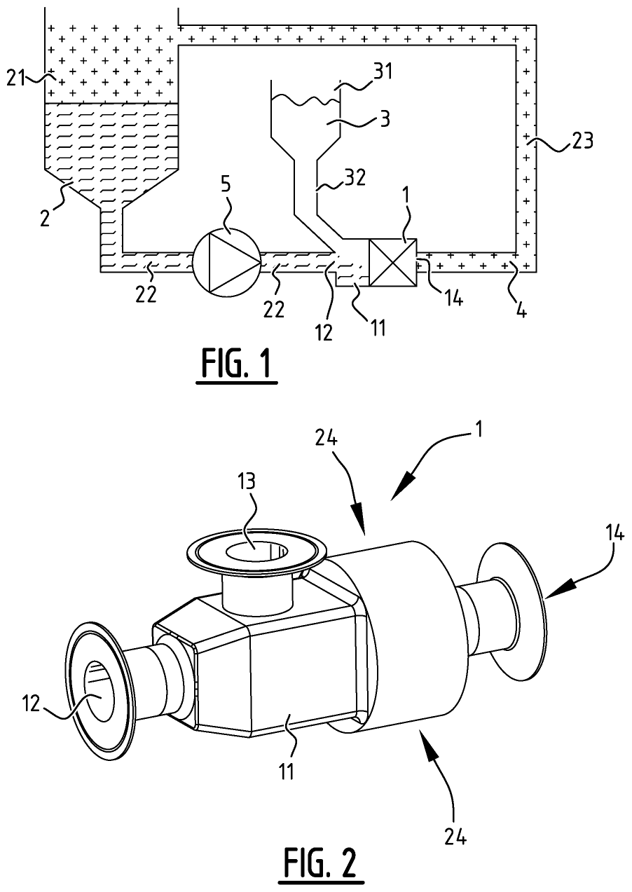

FIG. 1 shows a schematic view of a system for mixing a first substance and a second substance to form a mixed substance, in which a mixing device according to the invention is used;

FIG. 2 shows a perspective view of a mixing device according to the invention;

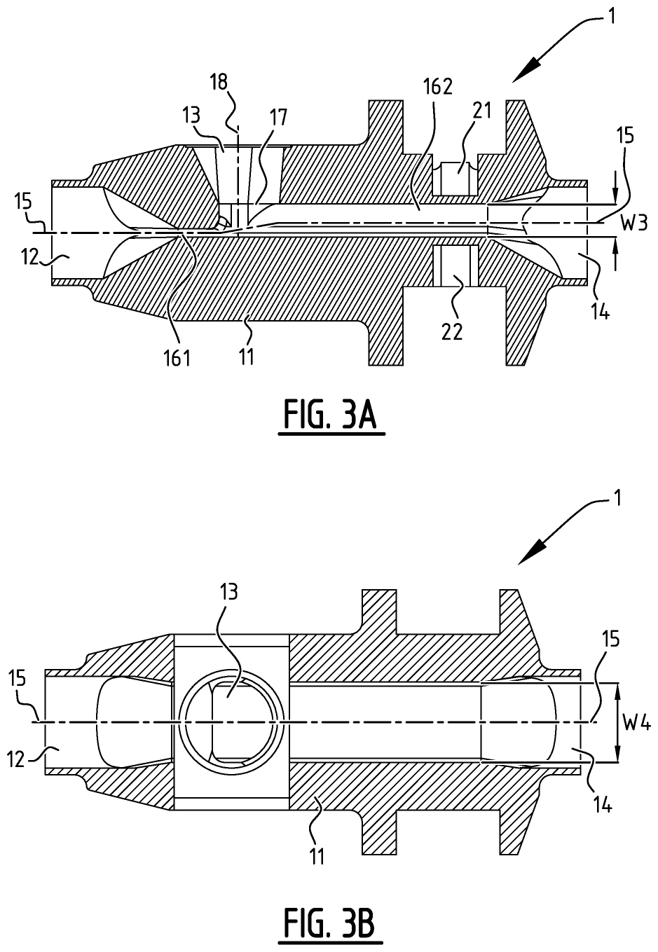

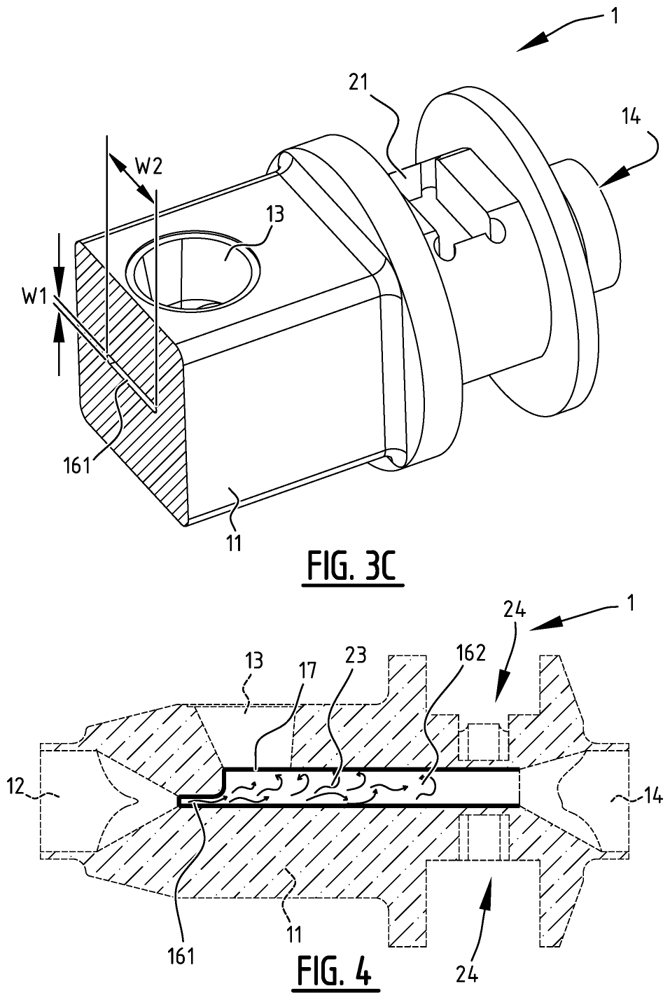

FIG. 3A shows a vertical cross section of the mixing device of FIG. 2 in side view;

FIG. 3B shows a partial horizontal cross section of the mixing device of FIG. 2 in top view;

FIG. 3C shows a vertical cross section of the mixing device of FIG. 2 in perspective view;

FIG. 3A shows a vertical cross section of the mixing device of FIG. 2 in side view, with additional turbulent eddies drawn in the Venturi tube section.

According to FIG. 1 a system for mixing a first substance 2, and a second substance 3 may comprise a mixing device 1 comprising a housing 11 having a first inlet 12 for said first substance 2, a second inlet 13 for said second substance 3 and an outlet 14 for the mixed substance 14. The inlets 12, 13 and the outlet 14 may be provided with respective flanges 121, 131, 141 for connecting respective pipes 22, 23, 32.

The first substance 2 is stored in a storage tank 21, of which the bottom outlet is connected to the inlet 12 by means of inlet pipe 22, in which a pump 5 is arranged to pump the first substance 2 into the mixing device at high pressure. The first substance 2 can be a fluid, for example, water. Said first substance can also be a mixture of a fluid with particles such as a powder but it can also be a powder in itself. The first substance can also be a gas or a mixture of a gas with a fluid and/or a solid particle.

The second substance 3 is stored in a hopper 31 located vertically above the mixing device 1, of which the bottom outlet is connected to the second inlet 13 of the mixing device 1 by mean so f pipe 32. Similarly, to the first substance, the second substance 3 can be a fluid, for example, water. Said second substance 3 can also be a mixture of a fluid with particles such as a powder but it can also be a powder in itself, for example a hydrophobic powder. The second substance 3 can also be a gas or a mixture of a gas with a fluid and/or a solid particle. It has been found that the mixing device 1 can be used to mix any combination of a fluid, solid and/or gas. The mixing device is preferably used to mix a fluid, such as water, with a solid, such as a hydrophobic powder.

The outlet 14 of the mixing device 1 is connected to an inlet of the storage tank 21 by means of a return pipe 23, such that the mixed substance may be recycled through the system until the required mixing grade is obtained. Alternatively, if the mixed substance has the required mixing grade after passing the mixing device 1 once, the pipe 23 may be connected to a separate storage tank for the finished product.

FIG. 2 shows that the mixing device 1 comprises a housing 11 having a first inlet 12, a second inlet 13 and an outlet 14 for the mixed substance 14. The inlets 12, 13 and the outlet 14 may be provided with respective flanges 121, 131, 141 for connecting respective pipes 22, 23, 32.

FIGS. 3A, 3B, 3C and 4 show the mixing device 1 using partial or entire cross sections thereof. FIG. 3A in particular shows a cross sectional side view of the mixing device 1 of FIG. 2, wherein the mixing device 1 is provided with a flow channel, having a central flow axis 15, between the first inlet 12 and the outlet 14. The flow channel is provided with a constricted Venturi tube section 161, 162.

A lateral feed opening 17 which is connected to the second inlet 13, is provided in the side wall of the constricted Venturi tube section, for example in the housing 11, and has a feed axis 18 which is substantially perpendicular to the flow axis 15 of the flow channel.

The constricted Venturi tube section 161, 162 is comprised of a first part 161 upstream of the feed opening 17, also referred to as the first constricted part 161, and a second part 162 downstream of the feed opening 17, also referred to as the second constricted part 162. The first constricted part 161 of the Venture tube section has a slit shape wherein the width w2 of the tube section forming the first constricted part in the vertical direction is smaller than the width w1 in the horizontal direction, as is shown in FIG. 3C. In this preferred embodiment the width w1 in the vertical direction is 2 mm and the width w2 in the horizontal direction is 20 mm. According to a preferred embodiment a length of the first constricted part 161, measured along the flow axis, is smaller than the width w2 in the horizontal direction. It is preferred that the first constricted part 161 comprises a constant cross sectional area along its flow axis. Put differently, the first constricted part 161 comprises a constant width w1 in the vertical direction and a constant width w2 along the horizontal direction, seen along the flow axis.

In the second constricted part 162 downstream from the lateral feed opening 17 the Venturi tube section has a width w3 in the vertical direction which is larger than the width w1 in vertical direction of the first part 161 upstream form the lateral feed opening 17. In this manner the flow channel is widened in a vertical direction in the second part 162 (at the side of the lateral feed opening 17). This feature improves the mixing process by enhancing turbulence at the side of the flow channel where the second substance is being introduced in the stream of the first substance.

By widening the second constricted part immediately after the lateral feed opening in one direction, strong turbulent eddies will be formed in the so created space, resulting in better and/or faster mixing. In Similarly, to the first constricted section it is preferred that the second constricted part comprises a constant cross section along the flow axis 15. It is noted that the wording ‘constricted’ refers to a constriction with respect to the first inlet size and/or outlet 14 size and that, in that context, the constricted section is not tapered or pseudo-conically shaped as is the inlet 12 or outlet 14 shown in FIG. 14, for example.

It is preferred that the bottom side of the wall of the flow channel integrally continues in both the first constricted part 161 and the second constricted part. In other words, the bottom side of the wall of the flow channel lies flush in both constricted parts 161, 162. In this way substantially no obstructions and/or fluid dynamic dead-zones are created where accumulation of particles can occur. Moreover, it is preferred that also at least a part of the side wall in the first constricted part and the second constricted part are flush. An advantage of the flush wall is that the Venturi section can be cleaned even more easily, such a venturi section is particularly advantageous in Clean In Place applications where cleanliness and hygiene are of the utmost importance, in particular in conjunction with a high production uptime of the mixing device 1. The flush walls allow the mixing device to be cleaned in place in an efficient manner. Moreover, it is preferred that the first and second constricted part 161, 162 are immediately adjacent to each other, i.e. the second constricted part 162 is immediately downstream of the first constricted part. Also, it is preferred that the transition between the first constricted part 161 and the second constricted part consists of a step. In other words, the width w1 of the first constricted part 161 seen in the vertical direction substantially immediately transitions to the third width w3 of the second constricted part 162. The corner formed by the step may be rounded to improve the cleanability. Also, because the first and second constricted part 161, 162 only differ in the width w1, w3 between the joint bottom side and their respective top sides of the wall, the second substance 3 is sucked into an already accelerated first substance thus improving suction, as well as more consistently providing said suction, of the second substance as well as improving the mixing of the two substances. Also, the accelerated speed of the mixed substances is maintained in the second constricted part 162. This effect of having an improved suction and mixing is particularly visible in comparison to known educators.

The tube section 19 between the cylindrical inlet 12 and the slit shaped inlet opening of the first part 161 has pseudo-conical shape to accommodate the transition from the inlet 12 of the mixing device to the constricted Venture tube section. Similarly the tube section 20 between the cylindrical outlet 14 and the slit shaped outlet opening of the second part 162 has pseudo-conical shape to accommodate the transition from the constricted Venture tube section to the outlet 14 of the mixing device 1. Preferably, exclusively the tube section 19 between the cylindrical inlet 12 and the slit shaped inlet opening of the first part 161 and the tube section 20 between the cylindrical outlet 14 and the slit shaped outlet opening of the second part 162 has a pseudo-conical shape. In other words, only a single convergence of a cross sectional area and a single divergence of the cross sectional area of the flow channel is present in the mixing device 1. The pseudo-conical shapes are considered to be a tapered or gradual transitions from one cross section to another. In comparison, the stepped transition between the first and second constricted part is an abrupt change in cross sectional area. Moreover, a transition area between the cylindrical inlet and the tube section 19 between the cylindrical inlet 12 and the slit shaped inlet opening is preferably seamless. Also a transition area between cylindrical outlet 14 and the tube section 20 between the cylindrical outlet 14 and the slit shaped outlet opening of the second part 162 is preferably seamless.

The housing 1 may be provided with magnets (not shown) in the cavities 21, 22 at both sides of the second part 162, such that the mixing substance may circulate through a magnetic field 24 in the second part 162 in order to positively affect the turbulent conditions of the flow.

The invention has thus been described by means of preferred embodiments. It is to be understood, however, that this disclosure is merely illustrative. Various details of the structure and function were presented, but changes made therein, to the full extent extended by the general meaning of the terms in which the appended claims are expressed, are understood to be within the principle of the present invention. The description and drawings shall be used to interpret the claims. The claims should not be interpreted as meaning that the extent of the protection sought is to be understood as that defined by the strict, literal meaning of the wording used in the claims, the description and drawings being employed only for the purpose of resolving an ambiguity found in the claims. For the purpose of determining the extent of protection sought by the claims, due account shall be taken of any element which is equivalent to an element specified therein. An element is to be considered equivalent to an element specified in the claims at least if said element performs substantially the same function in substantially the same way to yield substantially the same result as the element specified in the claims.

1. A mixing device for mixing a first substance and a second substance to form a mixed substance;
wherein said mixing device comprises a housing having a first inlet for said first substance, a second inlet for said second substance and an outlet for said mixed substance;
wherein a flow channel is arranged between said first inlet and said outlet, said flow channel having a flow axis between said first inlet and said outlet,
wherein said flow channel is provided with a constricted Venturi tube section, said Venturi tube section having a side wall;
wherein a lateral feed opening is provided in said side wall in a first lateral direction, which lateral feed opening is connected to said second inlet, and said opening having a feed axis in said first lateral direction which is substantially perpendicular to the flow axis of said flow channel;
wherein upstream from said lateral feed opening the side wall of said Venturi tube section forms a first constricted part having a first width in said first lateral direction and a second width in a second lateral direction perpendicular to said first lateral direction; and
wherein said second width is larger than said first width.

2. The mixing device in accordance with claim 1, wherein the width of said lateral feed opening in said second lateral direction is approximately equal to said second width of the first constricted part.

3. The mixing device in accordance with claim 1, wherein downstream from said lateral feed opening the side wall of said Venturi tube section forms a second constricted part having a third width in said first lateral direction and a fourth width in said second lateral direction, wherein seen in said first lateral direction, on a first lateral side of the flow channel the wall of said second constricted part is substantially flush with the wall of said first constricted part, and the flow channel is widened in said second constricted part in the direction of a second lateral side of the flow channel such that said third width is larger than said first width, said second lateral side being opposite the first lateral side.

4. The mixing device in accordance with claim 3, wherein the flow channel is widened in said second constricted part at the side of the lateral feed opening.

5. The mixing device in accordance with claim 4, wherein only the third width of the flow channel of the second constricted part is widened at the side of the lateral feed opening.

6. The mixing device in accordance with claim 3 5, wherein the third width of the flow channel in the second constricted part is constant, seen along the flow axis.

7. The mixing device in accordance with claim 1, wherein the first width of the flow channel in the first constricted part is constant, seen along the flow axis.

8. The mixing device in accordance with claim 3, wherein the flow channel between the first inlet and the outlet consists of the first constricted part and the second constricted part.

9. The mixing device in accordance with claim 1, wherein the housing is provided with magnets which extend adjacent the side wall of the second constricted part on both sides in the first lateral direction.

10. The mixing device in accordance with claim 1, wherein the second width of the first constricted part is more than 1.5 times the first width of the first constricted part.

11. The mixing device in accordance with claim 3, wherein the third width of the second constricted part is more than 1.25 times the width first width of the first constricted part.

12. The mixing device in accordance with claim 3, wherein the fourth width of the second constricted part is approximately equal to the second width of the first constricted part.

13. The mixing device in accordance with claim 1, wherein the width of the lateral feed opening in the direction of the flow axis is approximately equal to the width of the lateral feed opening in the second lateral direction.

14. The mixing device in accordance with claim 1, wherein the surface area of the lateral feed opening is more than 1.25 times the surface area of flow channel in the first constricted part.

15. The mixing device in accordance with claim 1, wherein the first width of the first constricted part is between 1 mm and 10 mm.

16. The mixing device in accordance with claim 3, wherein the third width of the second constricted part is between 2 mm and 100 mm.

17. The mixing device in accordance with claim 1, wherein the housing is made of one integral part.

18. A method for mixing a first substance and a second substance in a mixing device to form a mixed substance;
wherein said mixing device comprises a housing having a first inlet into which said first substance is pumped under pressure, a second inlet into which said second substance is fed, and an outlet from which said mixed substance is discharged;
wherein a flow channel is arranged between said first inlet and said outlet, said flow channel having a flow axis between said first inlet and said outlet,
wherein said flow channel is provided with a constricted Venturi tube section, said Venturi tube section having a side wall;
wherein a lateral feed opening is provided in said side wall in a first lateral direction, which lateral feed opening is connected to said second inlet, and said opening having a feed axis in said first lateral direction which is substantially perpendicular to the flow axis of said flow channel;
wherein upstream from said lateral feed opening the side wall of said Venturi tube section forms a first constricted part having a first width in said first lateral direction and a second width in a second lateral direction perpendicular to said first lateral direction; and
wherein said second width is larger than said first width.

19. The method in accordance with claim 18, wherein said first substance comprises mainly water and said second substance comprises a powder.

20. The method in accordance with claim 18, wherein the mixed substance is an emulsion or a dispersion, or a food emulsion or dispersion.
